(19) United States
(12) Patent Application Publication
(10) Pub. No.: US 2019/0378178 A1
(43) Pub. Date: Dec. 12, 2019

(54) CAPTURING ENERGY CONSUMPTION FOR VALIDATING A PRODUCT REVIEW

(71) Applicant: INTERNATIONAL BUSINESS MACHINES CORPORATION, Armonk, NY (US)

(72) Inventors: James E. Fox, Apex, NC (US); Marie Bradford, Durham, NC (US); Chad Lingmann, Bountiful, UT (US); Swaminathan Balasubramanian, Troy, MI (US)

(21) Appl. No.: 16/003,399

(22) Filed: Jun. 8, 2018

(51) Int. Cl. G06Q 30/02; H04L 29/08

(52) U.S. Cl. CPC G06Q 30/0282; H04L 67/12; H04L 67/22

(57) ABSTRACT

An approach is provided for generating a review of a product. An amount of usage of the product by a user is received from an energy monitoring device. It is determined that the amount of usage of the product exceeds a threshold amount. A message is sent to a computer utilized by the user. The message requests the user to author content that comments on the product. The content is authored by the user in response to the sending of the message and the content is received. A review of the product is generated by combining the content with an indication of the amount of usage of the product by the user.

### BACKGROUND

The present invention relates to managing product usage information, and more particularly to polling a user for a validated review of a product based on an amount of usage of the product by the user.

Online shoppers consult online product reviews to facilitate a selection of products to purchase. Online shoppers depend on the online reviews being accurate, but many are not accurate. Many online reviews are authored by reviewers who did not actually use a product (or used the product only minimally). Furthermore, many reviewers author reviews in a biased manner because they have been paid to author a positive or a negative review. Online retailers use known techniques to validate reviews based on an assumption that users that have a higher utilization of a product will author more accurate reviews because those users have more experience with the product. Known techniques of review validation use the purchase date of the product to determine a length of ownership of the product, and based on the length of ownership, identify the users who have had adequate time to have sufficient experience with the product to author an accurate review. Determining the length of ownership, however, does not ensure that the user has actually used the product. For example, if a person purchases a desk lamp from an online retailer, then authors a review one month later, it is assumed that the person has one month of experience with the desk lamp and therefore should have sufficient experience with the desk lamp to provide an accurate review. During the one month time period, the person may have turned on the desk lamp only once, and therefore may not have sufficient actual usage of the desk lamp to provide an accurate review. Actual usage statistics for the desk lamp may be provided if the desk lamp is augmented to a smart desk lamp (i.e., the desk lamp is made as a connected device that includes Internet of Things capabilities), but the cost of creating a smart desk lamp outweighs the benefits to the average desk lamp user.

### SUMMARY

In one embodiment, the present invention provides a method of generating a review of a product. The method includes a first computer receiving an amount of usage of the product by a user. The amount of usage is received from an energy monitoring device that is a nonintrusive load monitoring device that monitors and tracks the amount of usage of the product by the user. The method further includes the first computer determining that the amount of usage of the product by the user exceeds a predetermined threshold amount. The method further includes based on the amount of usage of the product by the user exceeding the predetermined threshold amount, the first computer sending a message to a second computer utilized by the user. The message requests that the user author content that comments on the product. The method further includes the first computer receiving the content from the second computer, where the content was authored by the user in response to the step of sending the message. The method further includes the first computer generating a review of the product by combining the content with an indication of the amount of usage of the product by the user.

In another embodiment, the present invention provides a computer program product for generating a review of a product. The computer program product includes a computer readable storage medium having program instructions stored on the computer readable storage medium. The computer readable storage medium is not a transitory signal per se. The program instructions are executed by a central processing unit (CPU) of a first computer system to implement a method. The method includes the first computer system receiving an amount of usage of the product by a user. The amount of usage is received from an energy monitoring device that is a nonintrusive load monitoring device that monitors and tracks the amount of usage of the product by the user. The method further includes the first computer system determining that the amount of usage of the product by the user exceeds a predetermined threshold amount. The method further includes based on the amount of usage of the product by the user exceeding the predetermined threshold amount, the first computer system sending a message to a second computer system utilized by the user. The message requests that the user author content that comments on the product. The method further includes the first computer system receiving the content from the second computer system, where the content was authored by the user in response to the step of sending the message. The method further includes the first computer system generating a review of the product by combining the content with an indication of the amount of usage of the product by the user.

In another embodiment, the present invention provides a first computer system including a central processing unit (CPU); a memory coupled to the CPU; and a computer readable storage medium coupled to the CPU. The computer readable storage medium contains instructions that are executed by the CPU via the memory to implement a method of generating a review of a product. The method includes the first computer system receiving an amount of usage of the product by a user. The amount of usage is received from an energy monitoring device that is a nonintrusive load monitoring device that monitors and tracks the amount of usage of the product by the user. The method further includes the first computer system determining that the amount of usage of the product by the user exceeds a predetermined threshold amount. The method further includes based on the amount of usage of the product by the user exceeding the predetermined threshold amount, the first computer system sending a message to a second computer system utilized by the user. The message requests that the user author content that comments on the product. The method further includes the first computer system receiving the content from the second computer system, where the content was authored by the user in response to the step of sending the message. The method further includes the first computer system generating a review of the product by combining the content with an indication of the amount of usage of the product by the user.

Embodiments of the present invention provide accurate product reviews that indicate how much reviewers actually used the products being reviewed. The product reviews are more accurate than reviews that merely verify the reviewers as actual purchasers of the products because someone who purchased a product may not have actually used the product or may not have used the product for a period of time that is long enough to ensure an accurate review.

### BRIEF DESCRIPTION OF THE DRAWINGS

FIG. 1 is a block diagram of a system for validating a review of a product, in accordance with embodiments of the present invention.

FIG. 2 is a flowchart of a process of validating a review of a product, where the process is implemented by the system of FIG. 1, in accordance with embodiments of the present invention.

FIG. 3 is a flowchart of a process of updating digital content using the process of FIG. 2, in accordance with embodiments of the present invention.

FIG. 4 is a flowchart of a process of controlling computing and network resources using the process of FIG. 2, in accordance with embodiments of the present invention.

FIG. 5 is an example of validating a review using the process of FIG. 2, in accordance with embodiments of the present invention.

FIG. 6 is a block diagram of a computer that is included in the system of FIG. 1 and that implements the process of FIG. 2, in accordance with embodiments of the present invention.

### DETAILED DESCRIPTION

### Overview

Embodiments of the present invention use energy monitoring technology to determine product usage statistics, which is leveraged to improve product review accuracy. Embodiments of the present invention recognize that an inherent accuracy of a product review varies based, at least in part, on a level of usage of the product by the user that authored the review. Embodiments of the present invention recognize that solicitation of product reviews, for a given product, from a group users that meet a threshold of product usage yields product reviews with a greater average accuracy when compared with an average accuracy of product reviews solicited from another group of users that have a level of usage for the given product that is below the threshold of product usage. Certain embodiments of the present invention leverage product review accuracy to generate digital content, e.g., website content and electronic commerce (e-commerce) content. Embodiments of the present invention recognize that an increase in the inherent accuracy of a product review included in digital content improves the digital content itself. As such, certain embodiments of the present invention provide an improvement to digital content by leveraging an increased accuracy of the data contained therein. Certain embodiments of the present invention recognize that selective sending of solicitations for product reviews to a group users that meet a threshold of product usage provides a mechanism to control the amount of computing and network resources consumed to generate product reviews with a given amount of accuracy. In certain embodiments, the threshold of product usage is set such that a number of users is predicted to receive a solicitation for a product review such that computing and network resources consumed for soliciting and generating the product reviews from the predicted number of users does not exceed a predetermined threshold quantity of computing and network resources. A product may be registered with an energy monitoring device, which tracks usage metrics of the product. After determining that the actual usage time of the product exceeds a predefined amount usage time, a review of the product is generated to include a certification of the actual usage time, which adds legitimacy to the review. An online shopper may view a first review having a certification of a first amount of actual usage time and a second review that does not include certified usage time. In making a decision about whether to purchase the product, the online shopper gives more weight to the first review than the second review based on the certified usage time included in the first review.

### System for Validating a Review of a Product

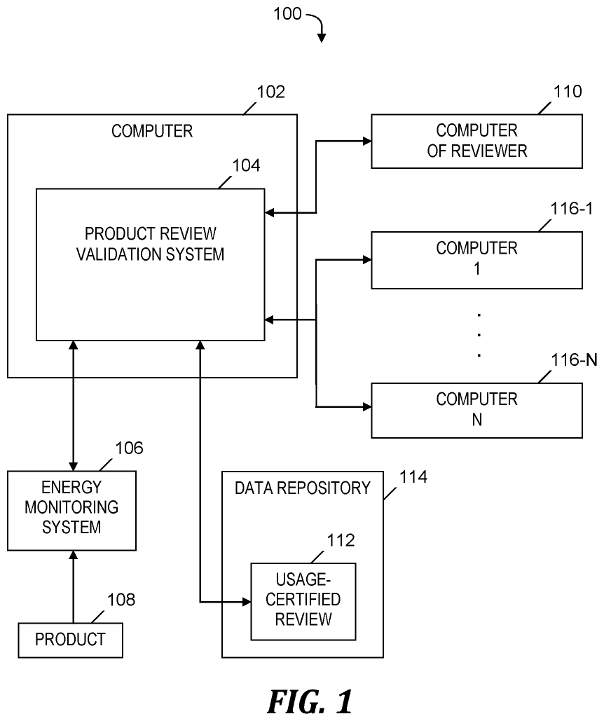

FIG. 1 is a block diagram of a system 100 for validating a review of a product, in accordance with embodiments of the present invention. System 100 includes a computer 102, which executes a software-based product review validation system 104 which validates reviews of products based on the reviewers' actual usage of the products. In one embodiment, product review validation system 104 generates or updates a website or other digital content with validated product reviews from multiple users. In one embodiment, product review validation system 104 controls computing and network resources consumed by soliciting and generating the product reviews. Product review validation system 104 may predict a number of users to receive a solicitation of a product review based on a predetermined threshold amount of usage to indicate an accurate review, so that a predetermined threshold quantity of computing and network resources will not be exceeded. In one embodiment, an online retailer or other e-commerce entity manages product review validation system 104. System 100 also includes an energy monitoring system 106, which is run by another computer (not shown) and monitors and tracks the energy consumption of a product 108 and one or more other products (not shown). As used herein, a product is defined as an electrical device or machine that is not a smart device and is not included in an internet of things system (i.e., a product is an unconnected device which is not connected to another device via a wireless protocol). Products include, for example, home appliances (e.g., stoves, refrigerators, freezers, toasters, microwave ovens, coffee makers, humidifiers, dehumidifiers, washing machines, clothes dryers, dishwashers, water heaters, water pumps, and air conditioners, and lighting fixtures) and consumer electronics (e.g., televisions, laptop computers, desktop computers, printers, DVD players, telephones, and smartphones).

Energy monitoring system 106 sends the monitored energy consumption data to product review validation system 104 via a computer network (not shown). In one embodiment, energy monitoring system 106 employs nonintrusive load monitoring which uses sensors clamped onto main power leads that feed a home to analyze changes in voltage and/or current to detect and identify devices being used in the home and to track the energy consumption of each of the devices. As one example, energy monitoring system 106 is included in a^{Sense}® Home Energy Monitor. Sense is a registered trademark of Sense Labs, Inc. located in Cambridge, Mass.

System 100 also includes a computer 110 which is used by a human reviewer to author a review that comments on product 108. The reviewer uses computer 110 to send the content of the review to product review validation system 104. Product review validation system 104 generates a usage-certified review 112, which includes a combination of the content of the review received from computer 110 and an indication of an amount of time that the reviewer actually used product 108 based on the energy consumption of product 108, which was received from energy monitoring system 106. Because usage-certified review 112 includes the indication of the usage time, the actual usage of product 108 by the reviewer is certified (i.e., validated) by product review validation system 104.

Product review validation system 104 may generate other usage-certified reviews (not shown) of product 108 and other product(s) and store the usage-certified reviews in a data repository 114. One or more users (i.e., online shoppers) who use computers 116-1, . . . , 116-N, respectively, where N is an integer greater than or equal to one, view usage-certified review 112 to make a decision whether to purchase product 108. The purchase decision of the user(s) is more influenced by the usage-certified review 112 than by other review(s) that do not certify usage time because the certified usage time allows the user(s) to determine whether the reviewer had adequate time to author an accurate review.

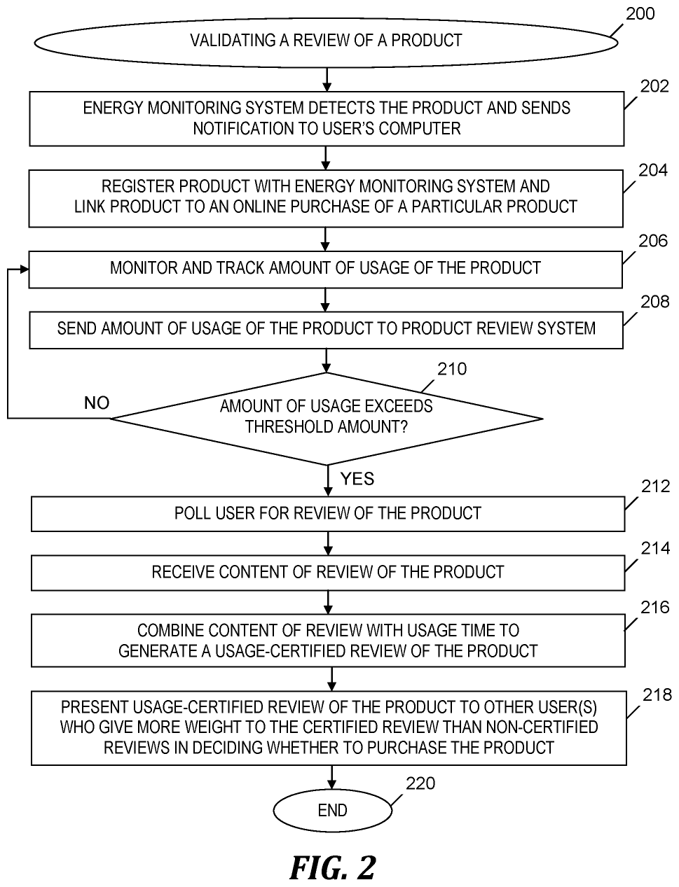

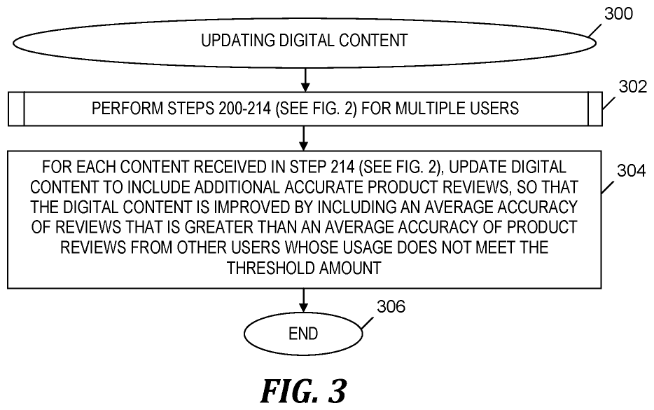

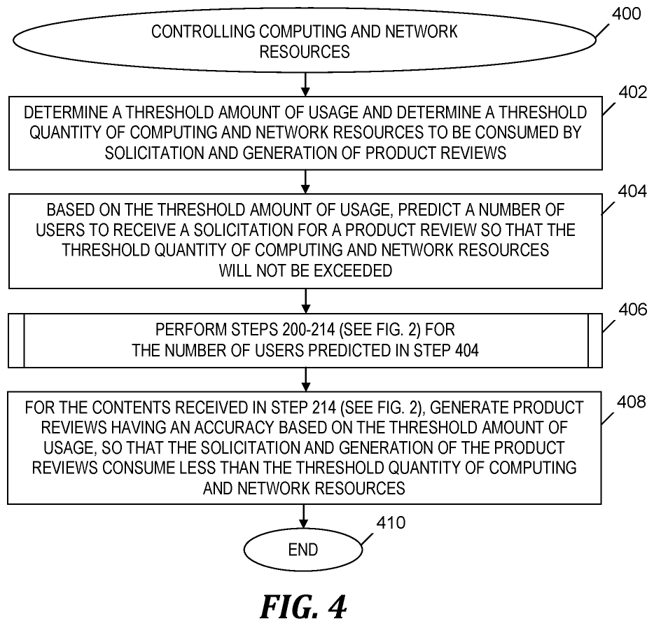

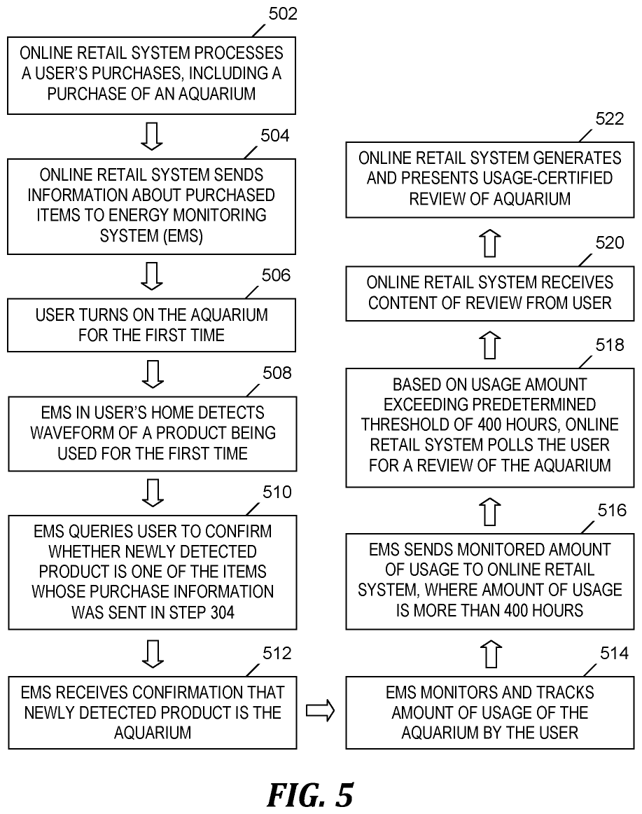

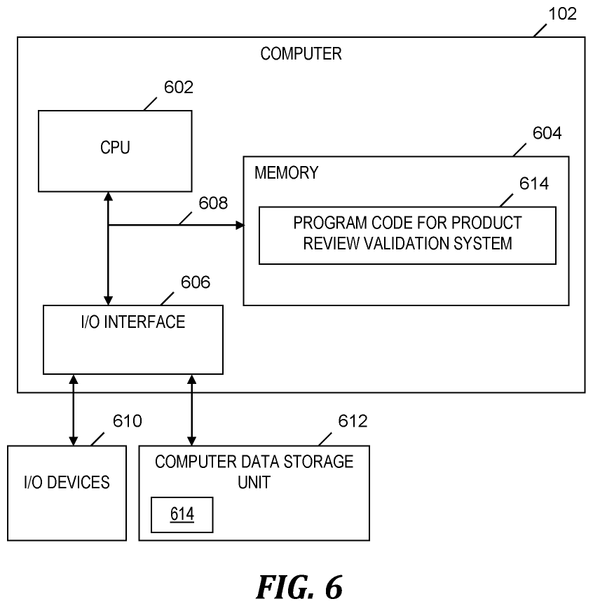

The functionality of the components shown in FIG. 1 is described in more detail in the discussion of FIG. 2, FIG. 3, FIG. 4, FIG. 5, and FIG. 6 presented below.

### Process for Validating a Review of a Product

FIG. 2 is a flowchart of a process of validating a review of a product, where the process is implemented by the system of FIG. 1, in accordance with embodiments of the present invention. The process of FIG. 2 starts at step 200. In step 202, energy monitoring system 106 (see FIG. 1) makes a first detection of product 108 (see FIG. 1) using energy and sends a notification to computer 110 (see FIG. 1).

In one embodiment, prior to step 204, an online retailer sends information about online purchases of a user to product review validation system 104 (see FIG. 1). In step 204, product review validation system 104 (see FIG. 1) registers product 108 (see FIG. 1) with energy monitoring system 106 (see FIG. 1) and using the aforementioned online purchase information, links product 108 (see FIG. 1) to an online purchase of a particular product. As used in the discussion of FIG. 2, the “user” is the purchaser of product 108 (see FIG. 1) and authors a review of product 108 (see FIG. 1).

In step 206, energy monitoring system 106 (see FIG. 1) monitors and tracks the amount of time that product 108 (see FIG. 1) is used (also referred to herein as “amount of usage” or “usage time”) (i.e., an amount of time during which product 108 (see FIG. 1) has consumed energy).

In step 208, energy monitoring system 106 (see FIG. 1) sends the amount of usage of product 108 (see FIG. 1) to product review validation system 104 (see FIG. 1).

In step 210, product review validation system 104 (see FIG. 1) determines whether the amount of usage sent in step 208 exceeds a predetermined threshold amount of usage. If product review validation system 104 (see FIG. 1) determines in step 210 that the amount of sage exceeds the threshold amount, then the Yes branch of step 210 is followed and step 212 is performed.

In step 212, product review validation system 104 (see FIG. 1) polls the user for a review of product 108 (see FIG. 1) (i.e., sends a message to the user via computer 110 (see FIG. 1), where the message requests that the user author content of a review that comments on product 108 (see FIG. 1)).

In step 214, product review validation system 104 (see FIG. 1) receives content of a review of product 108 (see FIG. 1) which was authored by the user and sent to product review validation system 104 (see FIG. 1) by computer 110 (see FIG. 1). The content of the review was authored by the user prior to step 214 in response to the user receiving the message that requested that the user author the content of the review.

In step 216, product review validation system 104 (see FIG. 1) generates usage-certified review 112 (see FIG. 1) by combining the content received in step 214 and the amount of usage sent in step 208.

In step 218, product review validation system 104 (see FIG. 1) presents usage-certified review 112 (see FIG. 1) to other one or more other users via computers 116-1, . . . , 116-N (see FIG. 1). In one embodiment, product review validation system 104 (see FIG. 1) presents usage-certified review 112 (see FIG. 1) as an accurate review based on the indication of the amount of usage of product 108 (see FIG. 1) being included in usage-certified review 112 (see FIG. 1).

In deciding whether to purchase product 108 (see FIG. 1), the aforementioned one or more other users give more weight to the usage-certified review 108 (see FIG. 1) than reviews that do not certify actual usage because the reviewer who authored the usage-certified review 112 (see FIG. 1) actually used product 108 (see FIG. 1) for an amount of time that is sufficient to allow the reviewer to author an accurate review.

In one embodiment, computer 102 (see FIG. 1) receives an online order to purchase product 108 (see FIG. 1) from one of the other users via computer 116-1 (see FIG. 1), where the order is received in response to usage-certified review 112 (see FIG. 1) being presented to the other user as an accurate review.

Following step 218, the process of FIG. 2 ends at step 220.

Returning to step 210, if product review validation system 104 (see FIG. 1) determines that the amount of usage does not exceed the threshold amount, then the No branch of step 210 is followed and the process of FIG. 2 loops back to step 206 in which energy monitoring system 106 (see FIG. 1) continues to monitor and track the amount of usage of product 108 (see FIG. 1).

In another embodiment, the one or more other users view usage-certified review 112 (see FIG. 1) that indicates a first amount of usage of product 108 (see FIG. 1) and a second review from another reviewer that indicates a second amount of usage of product 108 (see FIG. 1) that is less than the first amount of usage. In this case, the usage-certified review 112 (see FIG. 1) comments positively on product 108 (see FIG. 1) and the second review comments negatively on product 108 (see FIG. 1). One of the other users orders product 108 (see FIG. 1) based on the usage-certified review 112 (see FIG. 1) indicating an amount of usage that is greater the second amount of usage indicated in the second review.

In an alternate embodiment, product review validation system 104 (see FIG. 1) determines that the amount of usage of product 108 (see FIG. 1) does not exceed the threshold amount. The user (without being polled) authors content of a review of product 108 (see FIG. 1) and posts the review to product review validation system 104 (see FIG. 1). In response, product review validation system 104 (see FIG. 1) generates a review by combining the authored content and an indication of the amount of usage which does not exceed the threshold amount. Product review validation system 104 (see FIG. 1) presents the review to another user as an inaccurate review based on the indication of the amount of usage being included in the review and based on the amount of usage not exceeding the threshold amount. Presenting the review as an inaccurate review means that the review indicates that the author of the review has not used product 108 (see FIG. 1) for a period of time that is sufficient to author an accurate review. An online shopper who views the inaccurate review may decide to not purchase product 108 (see FIG. 1) because the review is presented as being inaccurate.

### Updating Digital Content

FIG. 3 is a flowchart of a process of updating digital content using the process of FIG. 2, in accordance with embodiments of the present invention. The process of FIG. 3 starts at step 300. In step 302, steps 200 through step 214 in FIG. 2 are performed for multiple users. In step 304, for each content received in step 214 (see FIG. 2), product review validation system 104 (see FIG. 1) updates a website or other digital content to include additional accurate product reviews, so that the website or other digital content is improved. The improvement to the website or other digital content is a result of including product reviews having an average accuracy that is greater than an average accuracy of product reviews from other users whose usage does not meet the threshold amount of usage (as used in step 210 in FIG. 2). The process of FIG. 3 ends at step 306.

In an alternate embodiment, the process of FIG. 3 includes generating digital content and step 304 is modified to include product review validation system 104 (see FIG. 1) generating a website or other digital content to include the accurate product reviews resulting from step 302, thereby ensuring that the website or other digital content has product reviews whose average accuracy is greater than the average accuracy of product reviews from other users whose usage does not meet the threshold amount of usage.

### Controlling Computing and Network Resources

FIG. 4 is a flowchart of a process of controlling computing and network resources using the process of FIG. 2, in accordance with embodiments of the present invention. The process of FIG. 4 starts at step 400. In step 402, product review validation system 104 (see FIG. 1) determines a threshold amount of usage, which if exceeded by a user of a product, indicates an accurate review of the product. Step 402 also includes product review validation system 104 (see FIG. 1) determining a threshold quantity of computing and network resources to be consumed by solicitation and generation of accurate product reviews.

In step 404, based on the threshold amount of usage, product review validation system 104 (see FIG. 1) predicts a number of users to receive a solicitation for a product review so that the threshold quantity of computing and network resources will not be exceeded.

In step 406, steps 200 through 214 in FIG. 2 are performed for the number of users predicted in step 404.

In step 408, for the contents received in step 214 (see FIG. 2) (which is included in step 406), product review validation system 104 (see FIG. 1) generates product reviews having an accuracy based on the threshold amount of usage, so that the solicitation and generation of the product reviews consume less than the threshold quantity of computing and network resources.

The process of FIG. 4 ends at step 410.

### Example

FIG. 5 is an example of validating a review using the process of FIG. 2, in accordance with embodiments of the present invention. In step 502, an online retail system processes purchases of a user, including a purchase of a desktop aquarium. The online retail system is executed by a computer system and includes product review validation system 104 (see FIG. 1).

In step 504, the online retail system sends information about the user's purchased items to energy monitoring system 106 (see FIG. 1).

In step 506, the aquarium is plugged in and turned on by the user for the first time. In step 508, which is performed in response to step 506, energy monitoring system 106 (see FIG. 1) detects a waveform of a product in the user's home being used for the first time. Step 506 is an example of step 202 (see FIG. 2).

In step 510, energy monitoring system 106 (see FIG. 1) queries the user to confirm whether the newly detected product (i.e., the product whose waveform was detected in step 508) is one of the purchased items whose information was sent in step 504.

In step 512, energy monitoring system 106 (see FIG. 1) receives a confirmation from the user that the newly detected product is the aquarium. Steps 510 and 512 are examples of actions included in step 204 (see FIG. 2).

In step 514, energy monitoring system 106 (see FIG. 1) monitors and tracks the amount of usage of the aquarium by the user. Step 514 is an example of step 206 (see FIG. 2).

In step 516, energy monitoring system 106 (see FIG. 1) sends the amount of usage monitored and tracked in step 514 to the online retailer system. The amount of usage is more than 400 hours. The online retailer previously stored 400 hours as a predetermined threshold amount of usage in association with an identification of the aquarium. Step 516 is an example of step 208 (see FIG. 2).

In step 518, based on the amount of usage exceeding the predetermined threshold amount of 400, the online retailer system determines that the user has had a sufficient amount of usage of the aquarium to author an accurate review of the aquarium and polls the user to request that the user author a review of the aquarium. Step 518 is an example of actions that are included in steps 210 and 212 (see FIG. 2).

In step 520, the online retailer system receives content of the review of the aquarium from the user. Step 520 is an example of step 214 (see FIG. 2).

In step 522, the online retailer system generates a usage-certified review of the aquarium, which includes the content received in step 520 and an indication of the amount of usage that was sent in step 516. Step 522 also includes the online retailer system presenting the usage-certified review to an online shopper who is shopping for an aquarium. Step 522 includes actions that are included in steps 216 and 218 (see FIG. 2). The indication of the amount of usage indicates that the review is authored by a user whose actual usage of the aquarium is sufficient to provide an accurate review. Because the indication of the amount of usage in the usage-certified review indicates a likelihood of an accurate review, the online shopper who is shopping for an aquarium and views the usage-certified review is influenced by the review and decides to purchase the aquarium.

### Computer System

FIG. 6 is a block diagram of a computer that is included in the system of FIG. 1 and that implements the process of FIG. 2, in accordance with embodiments of the present invention. Computer 102 is a computer system that generally includes a central processing unit (CPU) 602, a memory 604, an input/output (I/O) interface 606, and a bus 608. Further, computer 102 is coupled to I/O devices 610 and a computer data storage unit 612. CPU 602 performs computation and control functions of computer 102, including executing instructions included in program code 614 to perform a method of validating a review of a product, where the instructions are executed by CPU 602 via memory 604. CPU 602 may include a single processing unit, or be distributed across one or more processing units in one or more locations (e.g., on a client and server).

Memory 604 includes a known computer readable storage medium, which is described below. In one embodiment, cache memory elements of memory 604 provide temporary storage of at least some program code (e.g., program code 614) in order to reduce the number of times code must be retrieved from bulk storage while instructions of the program code are executed. Moreover, similar to CPU 602, memory 604 may reside at a single physical location, including one or more types of data storage, or be distributed across a plurality of physical systems in various forms. Further, memory 604 can include data distributed across, for example, a local area network (LAN) or a wide area network (WAN).

I/O interface 606 includes any system for exchanging information to or from an external source. I/O devices 610 include any known type of external device, including a display, keyboard, etc. Bus 608 provides a communication link between each of the components in computer 102, and may include any type of transmission link, including electrical, optical, wireless, etc.

I/O interface 606 also allows computer 102 to store information (e.g., data or program instructions such as program code 614) on and retrieve the information from computer data storage unit 612 or another computer data storage unit (not shown). Computer data storage unit 612 includes a known computer-readable storage medium, which is described below. In one embodiment, computer data storage unit 612 is a non-volatile data storage device, such as a magnetic disk drive (i.e., hard disk drive) or an optical disc drive (e.g., a CD-ROM drive which receives a CD-ROM disk).

Memory 604 and/or storage unit 612 may store computer program code 614 that includes instructions that are executed by CPU 602 via memory 604 to validate a review of a product. Although FIG. 6 depicts memory 604 as including program code, the present invention contemplates embodiments in which memory 604 does not include all of code 614 simultaneously, but instead at one time includes only a portion of code 614.

Further, memory 604 may include an operating system (not shown) and may include other systems not shown in FIG. 6.

Storage unit 612 and/or one or more other computer data storage units (not shown) may include usage-certified review 112 (see FIG. 1) and other usage certified reviews.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to validating a review of a product. Thus, an embodiment of the present invention discloses a process for supporting computer infrastructure, where the process includes providing at least one support service for at least one of integrating, hosting, maintaining and deploying computer-readable code (e.g., program code 614) in a computer system (e.g., computer 102) including one or more processors (e.g., CPU 602), wherein the processor(s) carry out instructions contained in the code causing the computer system to validate a review of a product. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of validating a review of a product.

While it is understood that program code 614 for validating a review of a product may be deployed by manually loading directly in client, server and proxy computers (not shown) via loading a computer-readable storage medium (e.g., computer data storage unit 612), program code 614 may also be automatically or semi-automatically deployed into computer 102 by sending program code 614 to a central server or a group of central servers. Program code 614 is then downloaded into client computers (e.g., computer 102) that will execute program code 614. Alternatively, program code 614 is sent directly to the client computer via e-mail. Program code 614 is then either detached to a directory on the client computer or loaded into a directory on the client computer by a button on the e-mail that executes a program that detaches program code 614 into a directory. Another alternative is to send program code 614 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 614 is transmitted to the proxy server and then it is stored on the proxy server.

Another embodiment of the invention provides a method that performs the process steps on a subscription, advertising and/or fee basis. That is, a service provider can offer to create, maintain, support, etc. a process of validating a review of a product. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 604 and computer data storage unit 612) having computer readable program instructions 614 thereon for causing a processor (e.g., CPU 602) to carry out aspects of the present invention.

The computer readable storage medium can be a tangible device that can retain and store instructions (e.g., program code 614) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 614) described herein can be downloaded to respective computing/processing devices (e.g., computer 102) from a computer readable storage medium or to an external computer or external storage device (e.g., computer data storage unit 612) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 614) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2, FIG. 3, and FIG. 4) and/or block diagrams (e.g., FIG. 1 and FIG. 6) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 614).

These computer readable program instructions may be provided to a processor (e.g., CPU 602) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 612) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 614) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of generating a review of a product, the method comprising the steps of:
a first computer receiving an amount of usage of the product by a user, the amount of usage being received from an energy monitoring device that is a nonintrusive load monitoring device that monitors and tracks the amount of usage of the product by the user;
the first computer determining that the amount of usage of the product by the user exceeds a predetermined threshold amount;
based on the amount of usage of the product by the user exceeding the predetermined threshold amount, the first computer sending a message to a second computer utilized by the user, the message requesting the user to author content that comments on the product;
the first computer receiving the content from the second computer, the content having been authored by the user in response to the step of sending the message; and
the first computer generating a review of the product by combining the content with an indication of the amount of usage of the product by the user.

2. The method of claim 1, further comprising the step of the first computer generating or updating a website or other digital content, so that a description of the product in the website or other digital content includes the review.

3. The method of claim 1, further comprising the steps of:
the first computer presenting the review to a second user as an accurate review based on the indication of the amount of usage of the product being included in the review; and
the first computer receiving an order from the second user to purchase the product in response to the review being presented to the second user as the accurate review.

4. The method of claim 1, further comprising the steps of:
the first computer receiving a second and third amounts of usage of the product by second and third users, respectively, the second amount of usage being received from a second energy monitoring device, the third amount of usage being received from a third energy monitoring device, and the third amount of usage being greater than the second amount of usage;
the first computer receiving second content from the second user that comments on the product;
the first computer receiving third content from the third user that comments on the product;
the first computer generating a second review of the product by combining the second content with a first indicator that indicates the second amount of usage of the product by the second user;
the first computer generating a third review of the product by combining the third content with a second indicator that indicates the third amount of usage of the product by the third user and further indicates that the third amount of usage is greater than the second amount of usage;
the first computer presenting the second and third reviews to a fourth user; and
the first computer receiving an order from the fourth user to purchase the product based on the third review rather than the second review in response to the third review having the second indicator that indicates the third amount of usage and indicates that the third amount of usage is greater than the second amount of usage.

5. The method of claim 1, further comprising the steps of:
the first computer receiving a second amount of usage of the product by a second user, the second amount of usage being received from a second energy monitoring device;
the first computer determining that the second amount of usage of the product by the second user does not exceed the predetermined threshold amount;
the first computer receiving content authored by the second user that comments on the product, the content being authored without the first computer sending a request for the content to another computer utilized by the second user; and
the first computer generating a second review of the product by combining the content with an indication of the second amount of usage of the product by the second user.

6. The method of claim 5, further comprising the step of the first computer presenting the second review to a third user as an inaccurate review based on the indication of the second amount of usage of the product being included in the review and the second amount of usage of the product not exceeding the predetermined threshold amount.

7. The method of claim 1, wherein the product is a non-smart device that is not connected to an internet of things system.

8. The method of claim 1, further comprising the steps of:
the first computer receiving a second amount of usage of the product by a second user, the second amount of usage being received from a second energy monitoring device;
the first computer determining that the second amount of usage of the product by the second user does not exceed the predetermined threshold amount;
the first computer receiving second content commenting on the product from a third computer utilized by the second user;
the first computer generating a second review of the product by combining the second content with an indication of the second amount of usage of the product by the second user; and
the first computer presenting the second review to a third user as an inaccurate review based on the second amount of usage of the product not exceeding the predetermined threshold amount, which results in the third user not purchasing the product based on the second review.

9. The method of claim 1, further comprising the step of:
providing at least one support service for at least one of creating, integrating, hosting, maintaining, and deploying computer readable program code in the computer, the program code being executed by a processor of the computer to implement the steps of receiving the amount of usage of the product by the user, determining that the amount of usage of the product by the user exceeds the predetermined threshold amount, sending the message to the second computer, receiving the content from the second computer, and generating the review of the product by combining the content with the indication of the amount of usage of the product by the user.

10. A computer program product for generating a review of a product, the computer program product comprising a computer readable storage medium having program instructions stored in the computer readable storage medium, wherein the computer readable storage medium is not a transitory signal per se, the program instructions are executed by a central processing unit (CPU) of a first computer system to cause the first computer system to perform a method comprising the steps of:
the first computer system receiving an amount of usage of the product by a user, the amount of usage being received from an energy monitoring device that is a nonintrusive load monitoring device that monitors and tracks the amount of usage of the product by the user;
the first computer system determining that the amount of usage of the product by the user exceeds a predetermined threshold amount;
based on the amount of usage of the product by the user exceeding the predetermined threshold amount, the first computer system sending a message to a second computer system utilized by the user, the message requesting the user to author content that comments on the product;
the first computer system receiving the content from the second computer system, the content having been authored by the user in response to the step of sending the message; and
the first computer system generating a review of the product by combining the content with an indication of the amount of usage of the product by the user.

11. The computer program product of claim 10, wherein the method further comprises the step of the first computer system generating or updating a website or other digital content, so that a description of the product in the website or other digital content includes the review.

12. The computer program product of claim 10, wherein the method further comprises the steps of:
the first computer system presenting the review to a second user as an accurate review based on the indication of the amount of usage of the product being included in the review; and
the first computer system receiving an order from the second user to purchase the product in response to the review being presented to the second user as the accurate review.

13. The computer program product of claim 10, wherein the method further comprises the steps of:
the first computer system receiving a second and third amounts of usage of the product by second and third users, respectively, the second amount of usage being received from a second energy monitoring device, the third amount of usage being received from a third energy monitoring device, and the third amount of usage being greater than the second amount of usage;
the first computer system receiving second content from the second user that comments on the product;
the first computer system receiving third content from the third user that comments on the product;
the first computer system generating a second review of the product by combining the second content with a first indicator that indicates the second amount of usage of the product by the second user;
the first computer system generating a third review of the product by combining the third content with a second indicator that indicates the third amount of usage of the product by the third user and further indicates that the third amount of usage is greater than the second amount of usage;
the first computer system presenting the second and third reviews to a fourth user; and
the first computer system receiving an order from the fourth user to purchase the product based on the third review rather than the second review in response to the third review having the second indicator that indicates the third amount of usage and indicates that the third amount of usage is greater than the second amount of usage.

14. The computer program product of claim 10, wherein the method further comprises the steps of:
the first computer system receiving a second amount of usage of the product by a second user, the second amount of usage being received from a second energy monitoring device;
the first computer system determining that the second amount of usage of the product by the second user does not exceed the predetermined threshold amount;
the first computer system receiving content authored by the second user that comments on the product, the content being authored without the first computer system sending a request for the content to another computer utilized by the second user; and
the first computer system generating a second review of the product by combining the content with an indication of the second amount of usage of the product by the second user.

15. The computer program product of claim 14, wherein the method further comprises the step of the first computer system presenting the second review to a third user as an inaccurate review based on the indication of the second amount of usage of the product being included in the review and the second amount of usage of the product not exceeding the predetermined threshold amount.

16. The computer program product of claim 10, wherein the product is a non-smart device that is not connected to an internet of things system.

17. A first computer system comprising:
a central processing unit (CPU);
a memory coupled to the CPU; and
a computer readable storage medium coupled to the CPU, the computer readable storage medium containing instructions that are executed by the CPU via the memory to implement a method of generating a review of a product, the method comprising the steps of:
the first computer system receiving an amount of usage of the product by a user, the amount of usage being received from an energy monitoring device that is a nonintrusive load monitoring device that monitors and tracks the amount of usage of the product by the user;
the first computer system determining that the amount of usage of the product by the user exceeds a predetermined threshold amount;
based on the amount of usage of the product by the user exceeding the predetermined threshold amount, the first computer system sending a message to a second computer system utilized by the user, the message requesting the user to author content that comments on the product;
the first computer system receiving the content from the second computer system, the content having been authored by the user in response to the step of sending the message; and
the first computer system generating a review of the product by combining the content with an indication of the amount of usage of the product by the user.

18. The first computer system of claim 17, wherein the method further comprises the step of the first computer system generating or updating a web site or other digital content, so that a description of the product in the website or other digital content includes the review.

19. The first computer system of claim 17, wherein the method further comprises the steps of:
the first computer system presenting the review to a second user as an accurate review based on the indication of the amount of usage of the product being included in the review; and
the first computer system receiving an order from the second user to purchase the product in response to the review being presented to the second user as the accurate review.

20. The first computer system of claim 17, wherein the method further comprises the steps of:
the first computer system receiving a second and third amounts of usage of the product by second and third users, respectively, the second amount of usage being received from a second energy monitoring device, the third amount of usage being received from a third energy monitoring device, and the third amount of usage being greater than the second amount of usage;
the first computer system receiving second content from the second user that comments on the product;
the first computer system receiving third content from the third user that comments on the product;
the first computer system generating a second review of the product by combining the second content with a first indicator that indicates the second amount of usage of the product by the second user;
the first computer system generating a third review of the product by combining the third content with a second indicator that indicates the third amount of usage of the product by the third user and further indicates that the third amount of usage is greater than the second amount of usage;
the first computer system presenting the second and third reviews to a fourth user; and
the first computer system receiving an order from the fourth user to purchase the product based on the third review rather than the second review in response to the third review having the second indicator that indicates the third amount of usage and indicates that the third amount of usage is greater than the second amount of usage.
